(19) United States
(12) Patent Application Publication
(10) Pub. No.: US 2007/0021383 A1
(43) Pub. Date: Jan. 25, 2007

(54) Organosilane quaternaries for acaricidal activity

(75) Inventor: Edwin R. Loder, Boyton Beach, FL (US)

Correspondence Address: RICHARD S. ROSS, ESQ., 4801 S. UNIVERSITY DR., # 237, FT. LAUDERDALE, FL, 33328, US

(73) Assignee: ROY MOORE

(21) Appl. No.: 11/187,284

(22) Filed: Jul. 25, 2005

(51) Int. Cl. A01N 55/00

(52) U.S. Cl. 514/63

(57) ABSTRACT

A method for killing acarids on a surface is disclosed. The method includes applying a solution comprising an organosilane quaternary compound to the surface such that the surface is wet. In one example, the compound comprises an organosilane quaternary such as 3-(trimethoxysilyl)propyldimethyloctadecyl ammonium chloride. In another example, the solution further comprises a surfactant and water. The surface comprises any one of clothes, bedding, a floor, a wall, and a carpet.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The invention disclosed broadly relates to the field of pest control, and more particularly relates to the field of acaricides for killing dust mites.

### BACKGROUND OF THE INVENTION

Dust mites are acarids (a type of arachnid, such as spiders and scorpions) that inhabit about 90% of homes in the U.S. Acarids, which were not known to exist until 1964, range in size between 0.1 mm and 0.5 mm. They live in all types of fibers, including carpets, clothing, fabric sofas, mattresses, pillows and bed sheets. Acarids, which subsist primarily on the dead skin particles that are constantly shed by humans, produce waste products in the form of fecal pellets and shells that are carried aloft by dust or air and inhaled by people. Since the discovery dust mite acarids, dust mite feces and shells have been gradually recognized as an important allergen that triggers asthma and other allergy attacks. Studies have shown that reducing exposure to dust mites leads to reductions in asthma attacks. Naturally, increasing efforts are being applied in the search for methods to kill dust mites in the domestic environment.

Various methods for killing dust mites are widely known. An acaricide is a pesticide that is aimed toward killing acarids. Acaricides comprising various materials have been commercially available for years. One example is Acarosan, a benzyl benzoate-based acaricide available from Bissell Homecare, Inc. of Grand Rapids, Mich.

Other well-known methods used for killing dust mites include a biological pesticide employing enzymes, such as described in U.S. Pat. No. 6,663,860, and an organic pesticide, as described in U.S. Pat. No. 5,935,943. A carpet treatment using borax (a tetraborate) and boric acid for controlling fleas and mites (i.e., animals of the Acari class) are described in U.S. Pat. No. 5,587,221. This patent, however, indicates that octaborate is expensive to produce. Further, the use of disodium octaborate tetrahydrate for controlling dust mites and other animals of the Acari class is described in U.S. Pat. No. 5,672,362. This patent further discloses the use of the crystalline form of disodiumoctaboratetetrahydrate as a carpet treatment for killing fleas.

Various insecticides are available for controlling insects in general. Disodium octaborate tetrahydrate, for example, is used for killing fleas, as described in U.S. Pat. No. 5,314,699. Acarids and insects, however, are very different creatures. For example, acarids have no sensory antennae, four pairs of legs and a one-part body, whereas insects have sensory antennae, three pairs of legs and a three-part body. Further, acarids excrete guanine and have no respiratory system, whereas insects excrete uric acid and ammonia and have a respiratory system. It is commonly known in the art that a chemical that is effective for controlling one type of pest is not necessarily effective for controlling another. Therefore, different chemicals are typically required for killing acarids as opposed to insects, although some insecticides are also usable as acaricides. Further, it is well-known in the art, however, that most acaricides and insecticides are ineffective in killing dust mites. The few acaricides or insecticides that are effective in killing dust mites must be used in concentrations that are too high to be safe for domestic applications.

The use of quaternary ammonium silicon compounds as antimicrobial agents is well known and is described in a wide variety of U.S. patents, such as U.S. Pat. Nos. 3,560,385, 5,794,736 and 3,814,739, the contents of which are hereby incorporated by reference in their entirety. It is also well-known in the art that these compounds possess certain antimicrobial properties useful for treating a variety of surfaces, substrates, and instruments, as described in a multitude of U.S. patents, such as U.S. Pat. Nos. 3,730,701, 3,794,736, 3,860,709, 4,282,366, 4,504,541, 4,615,937, 4,692,374, 4,408,996 and 4,414,268, which are hereby incorporated by reference in their entirety. Dust mites, however, have an entirely different characteristic than microbes, bacteria molds and mildew. Therefore, quaternary ammonium silicon compounds have not been used as acaricides.

Therefore, a need exists to overcome the problems with the prior art as discussed above, and particularly for a more efficient way to kill dust mites.

### SUMMARY OF THE INVENTION

Briefly, according to an embodiment of the present invention, a solution for killing acarids is disclosed. The solution includes a compound described by the chemical formula RₙSiX₄ₙ, where n is an integer from zero to three, R is a hydrolyzable organic group and each X is a hydrolyzable group. In one example, the compound comprises an organosilane quaternary such as 3-(trimethoxysilyl)propyldimethyloctadecyl ammonium chloride, otherwise known as Miltrol brand 3-(trimethoxysilyl)propyldimethyloctadecyl ammonium chloride available from Marinize Products Corporation of Hollywood, Fla. In another example, the solution further comprises a surfactant and water.

In another embodiment of the present invention, a method for killing acarids on a surface is disclosed. The method includes applying a solution comprising an organosilane quaternary compound to the surface such that the surface is wet. In one example, the compound comprises an organosilane quaternary such as 3-(trimethoxysilyl)propyldimethyloctadecyl ammonium chloride. In another example, the solution further comprises a surfactant and water. The surface comprises any one of clothes, bedding, a floor, a wall, and a carpet.

In another embodiment of the present invention, a system for killing acarids on a surface is disclosed. The system includes a solution including an organosilane quaternary compound, a container for holding the solution and an applicator for applying the solution to a surface. In one example, the compound comprises an organosilane quaternary such as 3-(trimethoxysilyl)propyldimethyloctadecyl ammonium chloride. In another example, the solution further comprises a surfactant and water. The applicator can be a sprayer or an aerosol dispenser. The surface comprises any one of clothes, bedding, a floor, a wall, and a carpet.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 is an illustration of a dust mite, other wise known as dermatophagoides pteronyssinus.

FIG. 2 is an illustration of a system for killing dust mites, in one embodiment of the present invention.

### DETAILED DESCRIPTION

The present invention provides a solution, system and method for killing acarids on a surface using a quaternary silicon compound. The method of the present invention includes applying a solution comprising an organosilane quaternary compound to the surface such that the surface is wet. The surface comprises any one of clothes, bedding, a floor, a wall, and a carpet. In one example, the compound comprises an organosilane quaternary such as 3-(trimethoxysilyl)propyldimethyloctadecyl ammonium chloride. In another example, the solution further comprises a surfactant and water.

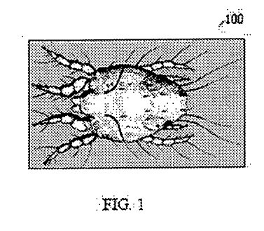

The present invention further provides a system for killing acarids, such as dust mites, on a surface. FIG. 1 is an illustration of a dust mite 100, other wise known as dermatophagoides pteronyssinus. The system includes a solution including an organosilane quaternary compound, a container for holding the solution and an applicator for applying the solution to a surface. In one example, the compound comprises an organosilane quaternary such as 3-(trimethoxysilyl)propyldimethyloctadecyl ammonium chloride. In another example, the solution further comprises a surfactant and water. The applicator can be a sprayer or an aerosol dispenser.

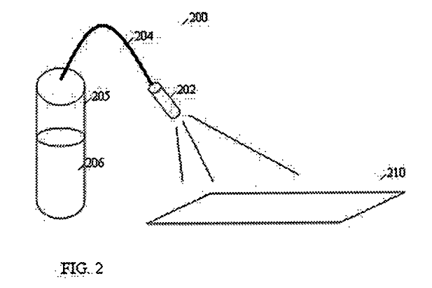

FIG. 2 is an illustration of a system 200 for killing dust mites, in one embodiment of the present invention. FIG. 2 includes a container 205, such as a cylinder container or any other jug, bottle or other type of container useful for carrying an insecticide or acaricide, for holding a solution 206 including an organosilane quaternary compound. In one example, the compound comprises an organosilane quaternary such as 3-(trimethoxysilyl)propyldimethyloctadecyl ammonium chloride. FIG. 2 also shows a hose 204 or duct for transporting the solution 206 to a sprayer 202, which may be a pump sprayer. The sprayer 202 is used to spray or apply the solution 206 onto a surface 210, such as a carpet, a floor or other surface. In accordance with one embodiment of the present invention, the surface 210 is spayed with the solution 206 until wet. This allows the organosilane quaternary compound to exhibit its acaricidal qualities upon any acarids or dust mites that exist upon the surface 210.

The benefits of organosilane quarternary acaricidal activity may be realized in several ways. With regard to solution 206 including an organosilane quaternary compound, organosilane quaternaries may be applied to materials and surfaces as an aqueous solution in a small container, such as container 205, with a trigger spray dispenser, such as sprayer 202. In another embodiment of the present invention, solution 206 may also be applied from an aerosol sprayer with the attendant advantages of the ease of application. An aerosol sprayer 202 allows for easy application of the solution 206 onto a wide area of a surface 210 as an aerosol sprayer typically disperses the solution 206 as a mist that falls onto the surface 210.

In yet another embodiment of the present invention, solution 206 may be applied in the final rise of residential and commercial laundry machines. In this embodiment, the solution 206 may include Miltrol brand 3-(trimethoxysilyl)propyldimethyloctadecyl ammonium chloride. The repetitive application of solution 206 in the laundry to materials such as bedding and clothing provides greater protection. The benefits of acaricidal activity for extended period of time are obtained from any of the aforementioned means of application due to the substantivity of the organosilane quaternary to the materials and surfaces, such as surface 210. In addition, the items treated and stored for extended periods of time will also receive the benefits of the organosilane quaternary moldicide and mildewcide activity.

In another embodiment of the present invention, organosilane quaternaries can be applied at the fiber stage of fabric manufacture. The solution 206 can be applied to fabric before and after dyeing and the advantages listed above, such moldicide activity, mildewcide activity and acaricide activity, obtained.

Organosilane quaternaries offer the additional advantage of rapid kill activity. Examination of time of kill of organosilane quaternaries against other acaricides in comparable test procedures show a 50% to 68% reduction in kill time if organosilane quaternaries are used. This feature, in addition to the extended protection provided by the organosilane quaternary attachment to applied surfaces, provides a combination of features not previously available.

In one embodiment of the present invention, the organosilane quaternary comprises organosilane quaternaries of the formula: RₙSiX₄ₙ where n is an integer from 0-3 and R is an independently hydrolysable organic group and each X is an independently hydrolysable group. In another embodiment of the present invention, the organosilane quaternary comprises 3-(trimethoxysilyl)propyldimethyloctadecyl ammonium chloride.

The organosilane quaternary of the present invention can be formulated with surfactants and water to provide a solution for spray application by a pump sprayer or an aerosol. Preferably, the surface being treated is dampened to wetness and allowed to dry. Materials or surfaces compatible with water are fit for treatment with the solution of the present invention. Similar formulations of solution 206 may be used as a final rinse treatment in residential and commercial laundries.

As described above, the solution 206 can comprise a water based solution. Any one of a variety of organosilane quaternaries know in the art are suitable for the production of water based compounds, products and compositions, as described in U.S. Pat. Nos. 5,411,585, 5,064,613, 5,145,592 and the publication entitled “A Guide to DC Silane Coupling Agent: (Dow Corning 1990), which are hereby incorporated by reference in their entirety. The aforementioned organosilane quaternaries are suitable for the formation of the water-based organosilane quaternary compounds, products and compositions of the present invention.

Again, as described above, the solution 206 can comprise an aqueous medium that may be manufactured using an aqueous siloxane synthesis method, such as that described in U.S. Pat. No. 4,390,712, which is hereby incorporated by reference. In an embodiment of the present invention, the aqueous siloxane synthesis method of U.S. Pat. No. 4,390,712 can be modified for compatibility with the solution of the present invention by performing the siloxane synthesis in the presence of the polyol stabilizer as defined herein, thereby forming a stabilized siloxane-water composition while still taking advantage of the accelerated kinetics of siloxane formation in aqueous media.

In an embodiment of the present invention, the solution 206 is manufactured by mixing a plurality of components, as described below. The components are mixed in the order listed with appropriate mixing times between additions to assure complete solution and uniform composition.

| | |
|---|---|
| 3-(trimethoxysilyl)propyldimethyloctadecyl ammonium chloride | 0.7% |
| water | 98.8% |
| nonyl phenol ethoxylate 4 mole EO | 0.7% |
| nonyl phenol ethoxylate 9 mole EO | 0.7% |
| Total | 100% |

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. A solution for killing acarids, comprising:
a compound described by the chemical formula RₙSiX₄ₙ, where n is an integer from zero to three, R is a hydrolyzable organic group and each X is a hydrolyzable group.

2. The solution of claim 1, wherein the compound comprises an organosilane quaternary.

3. The solution of claim 2, wherein the compound comprises:
3-(trimethoxysilyl)propyldimethyloctadecyl ammonium chloride.

4. The solution of claim 3, wherein the solution further comprises a surfactant.

5. The solution of claim 4, wherein the solution further comprises water.

6. The solution of claim 2, wherein the solution further comprises Miltrol brand 3-(trimethoxysilyl)propyldimethyloctadecyl ammonium chloride.

7. A method for killing acarids on a surface, comprising:
applying a solution comprising an organosilane quaternary compound to the surface such that the surface is wet.

8. The method of claim 7, wherein the step of applying comprises:
applying a solution comprising an organosilane quaternary compound to the surface such that the surface is wet, wherein the compound comprises 3-(trimethoxysilyl)propyldimethyloctadecyl ammonium chloride.

9. The method of claim 8, wherein the step of applying further comprises:
applying a solution comprising an organosilane quaternary compound to the surface such that the surface is wet, wherein the compound comprises 3-(trimethoxysilyl)propyldimethyloctadecyl ammonium chloride and wherein the surface comprises any one of clothes, bedding, a floor, a wall, and a carpet.

10. The method of claim 7, wherein the step of applying comprises:
spraying a solution comprising an organosilane quaternary compound on the surface such that the surface is wet.

11. The method of claim 10, wherein the step of applying comprises:
spraying a solution comprising an organosilane quaternary compound on the surface such that the surface is wet, wherein the surface comprises any one of clothes, bedding, a floor, a wall, and a carpet.

12. The method of claim 7, wherein the step of applying comprises:
spraying a solution comprising an organosilane quaternary compound on the surface such that the surface is wet, wherein the solution includes a surfactant and water.

13. The method of claim 12, wherein the step of applying comprises:
spraying a solution comprising an organosilane quaternary compound on the surface such that the surface is wet, wherein the solution includes a surfactant and water, and wherein the surface comprises any one of clothes, bedding, a floor, a wall, and a carpet.

14. The method of claim 7, wherein the step of applying comprises:
spraying a solution comprising an organosilane quaternary compound on the surface such that the surface is wet, wherein the solution includes Miltrol brand 3-(trimethoxysilyl)propyldimethyloctadecyl ammonium chloride.

15. A system for killing acarids on a surface, comprising:
a solution including an organosilane quaternary compound;
a container for holding the solution; and
an applicator for applying the solution to a surface.

16. The system of claim 15, wherein the organosilane quaternary compound comprises 3-(trimethoxysilyl)propyldimethyloctadecyl ammonium chloride.

17. The system of claim 15, wherein the solution further comprises a surfactant and water.

18. The system of claim 15, wherein the solution further comprises Miltrol brand 3-(trimethoxysilyl)propyldimethyloctadecyl ammonium chloride.

19. The system of claim 15, wherein the applicator comprises a sprayer.

20. The system of claim 15, wherein the applicator comprises an aerosol dispenser.
